(19) United States
(12) Patent Application Publication
(10) Pub. No.: US 2010/0097233 A1
(43) Pub. Date: Apr. 22, 2010

(54) Furnace filter alert

(75) Inventors: Suzanne Larson-Kolomyjec, Saint Charles, IL (US); Maunuel D. Seales, Dekalb, IL (US)

Correspondence Address: SUZANNE LARSON-KOLOMYJEC, 234 SEDGEWICK CIRCLE, ST. CHARLES, IL, 60174, US

(73) Assignee: Sword Technologies Corp., DeKalb, IL (US)

(21) Appl. No.: 12/288,375

(22) Filed: Oct. 21, 2008

(51) Int. Cl. G08B 21/00

(52) U.S. Cl. 340/627

(57) ABSTRACT

A dust particle detector comprised of one or more light beam emitters (10) and detectors (11), mounted on a hanging arm (50) which is attached to rear case (31). Enclosed in front case (30) and said rear case, a buzzer (4), battery (1), control potentiometer (5), switch (9) and electronic chips (2 and 3). After hanging the Filter Alert on the furnace filter, the light beam path soon becomes block with dust and dirt, which triggers the buzzer (4).

### FIELD OF THE INVENTION

The present invention relates to an alarm device adapted to be removable/attached to a furnace filter to alarm when dirt and/or dust accumulate on the filter surface.

### BACKGROUND OF INVENTION

Changing the furnace filter on a regular interval helps prolong the furnace life and keep it working more efficiently. Furnace filters are usually out of sight and out of mind. Too much dust and dirt on a filter will cause the fan motor and furnace equipment to stop working thus making the indoor air quality poor and allergy polluted.

The Filter Alert will aid in the prevention of the damage to the fan motor and furnace equipment and will help remind the user to change the filthy furnace filter.

### BRIEF DESCRIPTION OF THE DRAWINGS

FIG. 1—is a detailed exploded perspective view of the Filter Alert assembly.

FIG. 2—is a detail elevation view of the Clamp assembly 3D view.

FIG. 3—is an exploded view of Filter Alert front case with PC board.

FIG. 4—is a Schematic of the Filter Alert electronic circuit with part numbers and values.

### REFERENCE NUMERALS USED IN THE DRAWINGS AND DESCRIPTION

1. Battery
2. U2 (7805) regulator
3. U1 (NE555) timer
4. Buzzer
5. RV1 control potentiometer hole
6. LED hole
7. RV1 control potentiometer (500 Ohm)
8. Power LED
9. SW1 (SPST)
10. D1 (Emitter)
11. Q1 (Detector)
12. Infrared beam
13. R2 (47K Ohm)
14. Mounting screw
15. Mounting nut
19. PC Board standoff
20. PC Board
30. Front Case
31. Back Case
32. Hole for Emitter Sensor wires
33. Back Case Mounting Hole
34. Hole for Detector Sensor wires
41. 1K ohm resistor
42. 47K ohm resistor
43. 10K ohm resistor
44. 270 ohm resistor
45. 0.05 UF capacitor
46. 0.01 UF capacitor
50. Hanging arm
51. Hanging arm holding spring
52. Hanging arm Mounting Hole
53. Upper LED mount
54. Lower LED mount

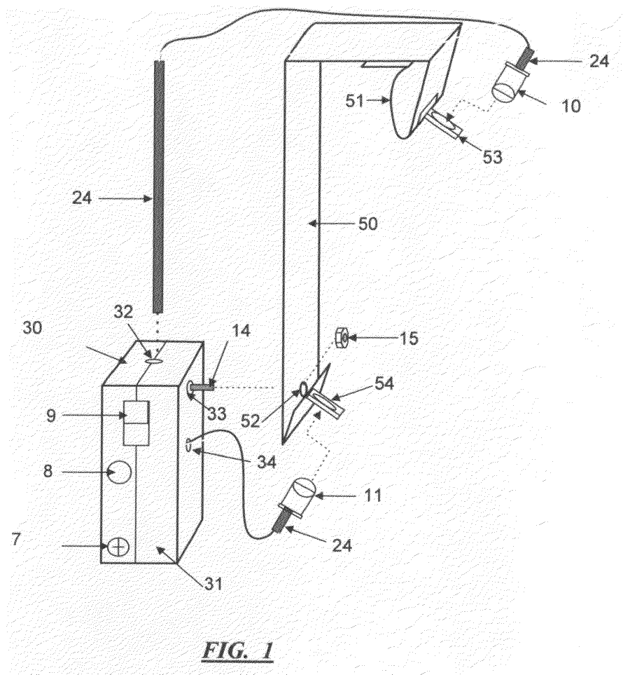

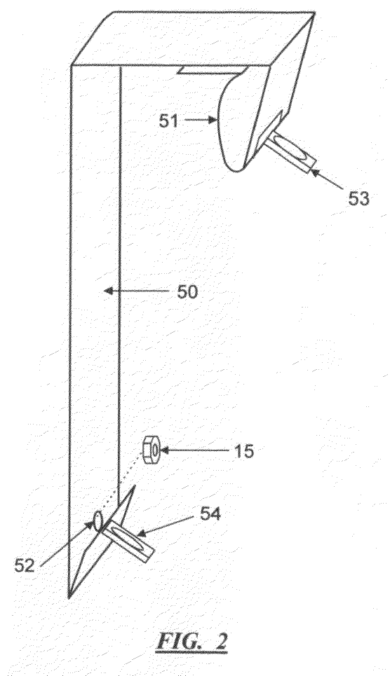

### FIGS. 1 AND 2—DETAILED DESCRIPTION OF FILTER ALERT

FIG. 1 is an exploded 3D view of the Filter Alert device subassembly. It shows how the emitter (10) and detector (11) attach to the hanging arm (50) by Upper LED holder (53) and Lower LED holder (54). The Upper LED holder (53) and Lower LED holder (54) are glue to the hanging arm (50). The back case (31) connects to hanging arm (50) by way of screw (14) and the nut (15) securing them together.

FIG. 2 shows the said hanging arm used to attach the Filter Alert device shown in FIG. 1 on the filter's backside. The hanging arm s holding spring (51) located on the said hanging arm which spring back into its position to firmly secure itself to the filter achieve the securing of the Filter Alert device to a filter. FIG. 2 also shows the upper LED mount (53) and the lower LED mount (54) which attaches to the hanging arm (50). The said hanging arm can be made of aluminum metal but its preferred that fireproof plastic used so that the paper filter will not become deformed when said hanging arm is applied.

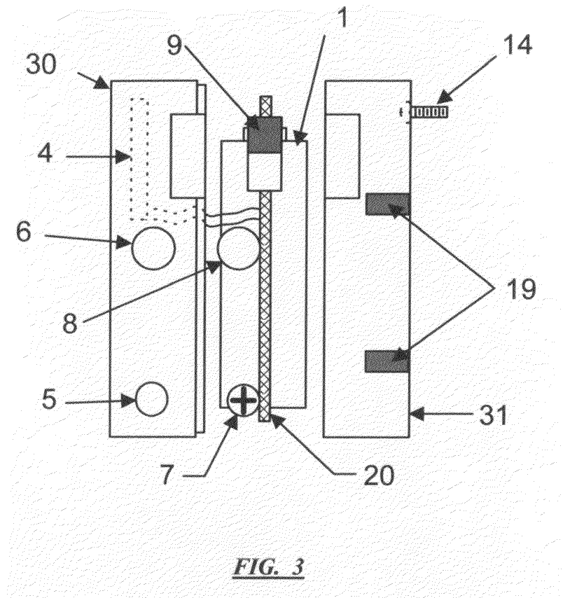

FIG. 3 shows a detail exploded view of the front cases (30) and rear case (31), control board (20), pc board mounts (19) and the battery (1). The buzzer (4) shown is in cased in the said front case which face the furnace blower motor. In the said rear case there is an x-ray view of the placement of the mounting screw (14) which fastens the said hanging arm by way of the mounting nut (15). The said cases [front and rear cases] are made of a fireproof plastic, which will prevent any damage to the furnace filter in case fire.

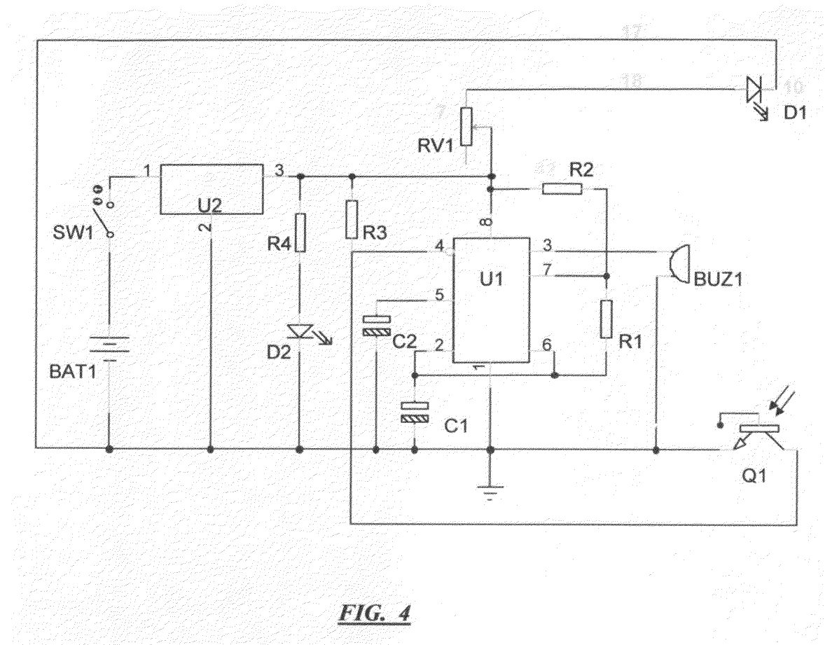

FIG. 4 depicts a general circuit diagram of the control broad (20) of the present Invention. An electronic timer chip (3) which is located on the said control board controls all the operation of the said emitter and detector, RV1 control potentiometer (7), buzzer 4, and the power LED. Turning switch (9) to the on position applies power to the said control board and emitter to emit an infrared light beam through the filter to the said detector deactivating the electronic timer chip (3) and said buzzer. Over a period dust and dirt accumulates on the filter surface interrupting the infrared light beam between said emitter and detector the said electronic timer chip becomes active sending pulses to the said buzzer causing it to emit a loud high pitch oscillating sound through the ventilation ducts.

The power supply uses a 9-volt battery (1), which uses a voltage regulator (2) to drops the voltage down to 5 volts. This allows the said control broad, and said buzzer to operate longer with out consuming all the battery power. As shown in FIG. 3 the said battery is readily assessable through the said front case by unsnapping it from said rear case. This may be a screw fastener, snap, or other suitable fasting closure means.

### Operation

In order to use the Filter Alert, the user hangs the unit on the furnace filter by way of its hanging arm (50) with rear cases (31) facing the backside of the new filter. Then by moving, the switch (9) to the on position will cause the power LED (8) to light up showing that the unit is ready for service. When adjusting RV1 control potentiometer (7) it controls the triggering point of the control broad (20) to enable the buzzer (4). Depending on how much dust/dirt the user wants the filters surface to be, the said RV1 control potentiometer can be adjusted to allow a moderate amount to extreme amounts of dust and dirt on the filter before triggering the said buzzer. The infrared emitter 10 sends an infrared beam of light to the detector (11) which measures a cross section of the furnace filter surface. When dust and dirt accumulates in the path, of the said emitter and detector this interrupts the infrared light beam and enables the electronic timer chip (3) becomes active sending pulses to the said buzzer causing it to emit a loud high pitch oscillating sound throughout the ventilation ducts.

The battery 1 in the Filter Alert device should be replaced every 3 to 4 months to maintain reliable operating service. The said infrared emitter and detector could be substituted with a normal light emitter and light detector.

We claim:

1. A dust and dirt alarm detector, comprising:
a. One or more light-emitters aimed at and spaced apart from one or more light-detectors, mounted at opposite ends on the hanging arm, allowing the said light emitters to illuminate a light beams through front of the furnace filter to said light detector in the rear of furnace filter.
b. A front and rear case attached to said hanging arm.
c. An electronic circuit with a voltage regulator, battery, on/off switch, LED and buzzer mounted and enclosed in said cases.
d. The said buzzer is triggered by the said electronic circuit when the said one or more light-emitters, illuminated light beams are interrupted from the said one or more light-detectors.

2. The apparatus of claim 1 will activate said buzzer through the ventilation ducts system of the furnace unit.
Whereby the Filter Alert's said buzzer will alarm, alerting the user to check or replace the said furnace filter.
